(19) United States
(12) Patent Application Publication
(10) Pub. No.: US 2026/0057444 A1
(43) Pub. Date: Feb. 26, 2026

(54) AUTOMATED COMPUTERIZED SYSTEM AND METHOD FOR PROVIDING A SURETY BOND

(71) Applicant: Roosevelt Road Specialty, New York, NY (US)

(72) Inventor: Daniel G. Hickey, JR., New York, NY (US)

(73) Assignee: Roosevelt Road Specialty, New York, NY (US)

(21) Appl. No.: 18/813,595

(22) Filed: Aug. 23, 2024

(51) Int. Cl. G06Q 40/06; G06Q 40/08

(52) U.S. Cl. CPC G06Q 40/06; G06Q 40/08

(57) ABSTRACT

In an embodiment, an automated computerized system for providing a surety bond is disclosed. The system includes a plurality of computing devices communicatively coupled to one another over a network. The system further includes an underwriting server communicatively coupled to a client device over the network to receive first electronically transmitted information representing an application for a surety bond from the client device. The system further includes a database electronically storing contractual data from a contract between the principal and obligee, a contractual data aggregator configured to retrieve data from the database and to verify signatures on the contract, and a monitoring module configured to monitor whether one or more conditions for payment of the penal sum are met.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to the field of finance, and in particular, an automated computerized system for providing a surety bond.

A ceding insurer's ability to take credit for reinsurance is governed by the laws and regulations for credit for reinsurance enacted by the state in which the ceding insurer is domiciled. Nearly every state in the U.S. has adopted the National Association of Insurance Commissioners (NAIC) model law and regulation for credit for reinsurance. In general, the NAIC model law and regulation provide several different methods for a ceding insurer to take a reduction from liability for reinsurance it has ceded. A penalty under Schedule F—the section in an annual insurance statement in which reinsurance transactions are disclosed-results when the ceding insurer must reduce its surplus balance because the reinsurance from an unaccredited or unauthorized reinsurer does not serve as a reduction from liability.

A reinsurer that is not appropriately licensed in the U.S. or a reciprocal jurisdiction and is not a certified reinsurer or an accredited reinsurer can only have its reinsurance (known as “unauthorized reinsurance”) qualify to reduce the ceding insurer's liability by providing security for the full amount of the obligations under the reinsurance agreement.

Under the NAIC model law and regulation, the acceptable security for such an unauthorized reinsurer consists of (1) cash, (2) approved securities (bonds, stocks, etc.), (3) letters of credit, or (4) “other security acceptable to the Insurance Regulator.” A surety bond may therefore be considered acceptable security under clause (4) by the state insurance department of the domicile state of the ceding insurer.

Thus, there is a need for an improved method and system for providing a surety bond. The present invention addresses the limitations of traditional approaches and offers a modern solution to streamline the process for obtaining a surety bond.

### SUMMARY

The present invention comprises an automated computerized system for providing a surety bond. The system comprises a plurality of computing devices communicatively coupled to one another over a network. The system comprises an underwriting server communicatively coupled to a client device over the network. The underwriting server is configured to receive first electronically transmitted information representing an application for a surety bond from the client device. The first electronically transmitted information includes at least a name of a principal, a name of an obligee, and a penal sum.

The system further comprises a database electronically storing contractual data from a contract between the principal and oblige. The system further comprises a contractual data aggregator configured to retrieve data from the database and to verify signatures on the contract. The system further comprises a monitoring module configured to monitor whether one or more conditions for payment of the penal sum are met.

The underwriting server comprises a plurality of communicatively coupled computer system components configured to aggregate electronic content that shows whether one or more guidelines for the surety bond are met. The underwriting server further comprises an assessor configured to analyze the aggregated electronic content to verify whether the one or more guidelines for the surety bond are met, perform underwriting for the surety bond in the application based on the verification, store underwriting data in a cache associated with the client device, and generate a surety bond based on the underwriting.

In some embodiments, the surety bond guarantees unearned premium for an unauthorized reinsurance company. The assessor may be configured to generate the surety bond in response to a change in the stored underwriting data or elapsing of a predetermined amount of time. In some embodiments, the contract between the principal and obligee is an interest and liabilities contract. The one or more conditions for payment of the penal sum may comprise a failure by the principal to pay an amount owed under the contract, a court order or settlement agreement requiring the obligee to make a payment demand upon the surety, and an amendment, modification, cancellation, termination, or non-renewal of the surety bond.

In some embodiments, the system further comprises a payment module which, based on a determination by the monitoring module that one or more conditions for payment of the penal sum are met, is configured to calculate a percentage of the penal sum owed. The percentage may be some or all of the penal sum. The payment module is further configured to pay the percentage.

In some embodiments, the plurality of computer system components comprises a loss run analyzer configured to retrieve a loss run report from the principal and analyze the principal's loss history with the obligee. The plurality of computer system components may further comprise an investment tracker configured to retrieve a portfolio of the principal's investments comprising stocks, bonds, cash, and real estate. The plurality of computer system components may further comprise a registration verifier configured to interface with a state insurance department server to retrieve registration information about the principal and obligee and verify their registration status.

In another embodiment, an automated computerized method for providing a surety bond is disclosed. The method is performed by a plurality of computing devices communicatively coupled to one another over a network. The method comprises receiving, by an underwriting server communicatively coupled to a client device over the network, first electronically transmitted information representing an application for a surety bond from the client device. The first electronically transmitted information includes at least a name of a principal, a name of an obligee, and a penal sum. The method further comprises storing, by an electronic database, contractual data from a contract between the principal and oblige.

The method further comprises retrieving, by a contractual data aggregator, data from the electronic database and verifying, by the contractual data aggregator, signatures on the contract. The method further comprises monitoring, by a monitoring module, whether one or more conditions for payment of the penal sum are met and aggregating, by a plurality of communicatively coupled computer system components on the underwriting server, electronic content that shows whether one or more guidelines for the surety bond are met.

The method further comprises, by an assessor on the underwriting server, analyzing the aggregated electronic content to verify whether the one or more guidelines for the surety bond are met, performing underwriting for the surety bond in the application based on the verification, storing underwriting data in a cache associated with the client device, and generating a surety bond based on the underwriting.

In some embodiments, generating the surety bond comprises generating a surety bond guaranteeing unearned premium for an unauthorized reinsurance company. Generating the surety bond may comprise generating, by the assessor, the surety bond in response to a change in the stored underwriting data or elapsing of a predetermined amount of time.

In some embodiments, storing contractual data from the contract between the principal and obligee comprises storing contractual data from an interest and liabilities contract between the principal and obligee. Monitoring whether one or more conditions for payment of the penal sum are met may comprise monitoring for a failure by the principal to pay an amount owed under the contract, a court order or settlement agreement requiring the obligee to make a payment demand upon the surety, and an amendment, modification, cancellation, termination, or non-renewal of the surety bond.

In some embodiments, the method further comprises calculating, by a payment module, a percentage of the penal sum owed and paying the percentage based on a determination by the monitoring module that one or more conditions for payment of the penal sum are met. The percentage may be some or all of the penal sum. The method may further comprise a loss run analyzer for retrieving a loss run report from the principal and analyzing the principal's loss history with the obligee. The method may further comprise an investment tracker on the underwriting server for retrieving a portfolio of the principal's investments comprising stocks, bonds, cash, and real estate. The method may further comprise a registration verifier for interfacing with a state insurance department server to retrieve registration information about the principal and oblige and verifying the registration status of the principal and obligee.

In another embodiment, non-transitory computer-readable media comprising program code that when executed by a programmable processor in an underwriting server causes execution of an automated computerized method is disclosed. The method is performed by a plurality of computing devices communicatively coupled to one another over a network. The computer readable media comprises computer program code for receiving, by an underwriting server communicatively coupled to a client device over the network, first electronically transmitted information representing an application for a surety bond from the client device. The first electronically transmitted information includes at least a name of a principal, a name of an obligee, and a penal sum.

The computer-readable media further comprises computer program code for storing, by an electronic database, contractual data from a contract between the principal and obligee, retrieving, by a contractual data aggregator, data from the electronic database, and verifying, by the contractual data aggregator, signatures on the contract.

The computer-readable media further comprises computer program code for monitoring, by a monitoring module, whether one or more conditions for payment of the penal sum are met, and aggregating, by a plurality of communicatively coupled computer system components on the underwriting server, electronic content that shows whether one or more guidelines for the surety bond are met.

The computer-readable media further comprises computer program code for analyzing, by an assessor on the underwriting server, the aggregated electronic content to verify whether the one or more guidelines for the surety bond are met, performing, by the assessor, underwriting for the surety bond in the application based on the verification, storing, by the assessor, underwriting data in a cache associated with the client device, and generating, by the assessor, a surety bond based on the underwriting.

In some embodiments, generating the surety bond comprises generating a surety bond guaranteeing unearned premium for an unauthorized reinsurance company.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a diagram of an automated computerized system for providing a surety bond according to embodiments of the present invention.

FIG. 2 is a diagram of components of an underwriting server according to embodiments of the present invention.

FIGS. 3A and 3B illustrate a flow diagram of an example automated computerized process for providing a surety bond according to embodiments of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

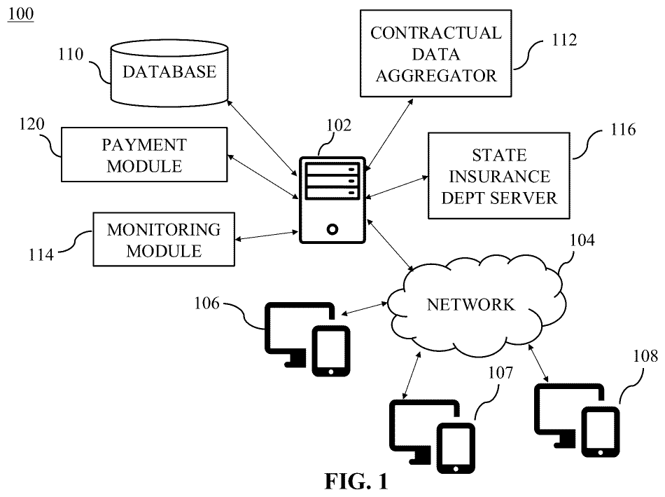

With reference to FIG. 1, an automated computerized system 100 for providing a surety bond is disclosed in accordance with embodiments of the invention. System 100 comprises client devices 106-108 comprising principal device 106 used by a purchaser of a surety bond, obligee device 107 used by a party requiring that the principal purchase the surety bond as collateral, and surety device 108 used by a party that guarantees the work of the principal and is liable for claims against the principal. According to an embodiment, the principal is an unauthorized reinsurance company and the obligee is an insurance company ceding reinsurance.

Principal device 106, obligee device 107, and surety device 108 may comprise computing devices (e.g., personal computers, mobile devices, terminals, laptops, personal digital assistants (PDA), cell phones, tablet computers, or any computing device having a central processing unit and memory unit capable of connecting to a network). Client devices 106-108 may also comprise a graphical user interface (GUI) or a browser application provided on a display (e.g., monitor screen, LCD or LED display, projector, etc.). A client device may vary in terms of capabilities or features. A client device may also include or execute an application to communicate content, such as, for example, textual content, multimedia content, or the like. A client device may also include or execute an application to perform a variety of possible tasks, such as browsing, searching, and displaying various forms of content. A client device may include or execute a variety of operating systems, including a personal computer operating system, such as a Windows, Mac OS or Linux, or a mobile operating system, such as IOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The foregoing is provided to illustrate that claimed subject matter is intended to include a wide range of possible features or capabilities.

According to an embodiment, system 100 is configured to provide a surety bond that guarantees Unearned Premiums (UEP) for an unauthorized reinsurance company or principal. System 100 comprises an underwriting server 102, a database 110, a contractual data aggregator 112, a monitoring module 114, a state insurance department server 116, and a payment module 120. Underwriting server 102 may vary widely in configuration or capabilities but is comprised of at least a special-purpose digital computing device including at least one or more central processing units and memory. Underwriting server 102 may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Database 110 is configured to electronically store contractual data from a contract executed between principal device 106 and obligee device 107. In an embodiment, the contract comprises an interest and liabilities contract. Contractual data aggregator 112 is configured to retrieve contractual data from database 110 and to verify signatures from principal device 106 and obligee device 107 on the contract.

Monitoring module 114 is configured to monitor whether one or more conditions for payment of a penal sum are met. For example, conditions for payment of the penal sum may comprise a failure by principal device 106 to pay an amount owed under the contract, a court order or settlement agreement requiring obligee device 107 to make a payment demand upon surety device 108, or an amendment, modification, cancellation, termination, or non-renewal of the surety bond. As such, if principal device 106 fails to pay the UEP, obligee device 107 can demand payment of the UEP from surety device 108.

If monitoring module 114 determines that one or more conditions for payment of the penal sum are met, payment module 120 is configured to calculate a percentage of the penal sum owed to obligee device 107 and to pay the percentage to obligee device 107. In an embodiment, the calculated percentage may be some or all of the penal sum.

Network 104 is configured to connect principal device 106, obligee device 107, and surety device 108 with underwriting server 102. Network 104 may be any suitable type of network allowing transport of data communications across thereof. Network 104 may also include mass storage, such as network attached storage (NAS), a storage area network (SAN), cloud computing and storage, or other forms of computer or machine-readable media, for example. In one embodiment, network 104 may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using the Advanced Encryption Standard (AES) with a 256-bit key size, or any other encryption standard known in the art.

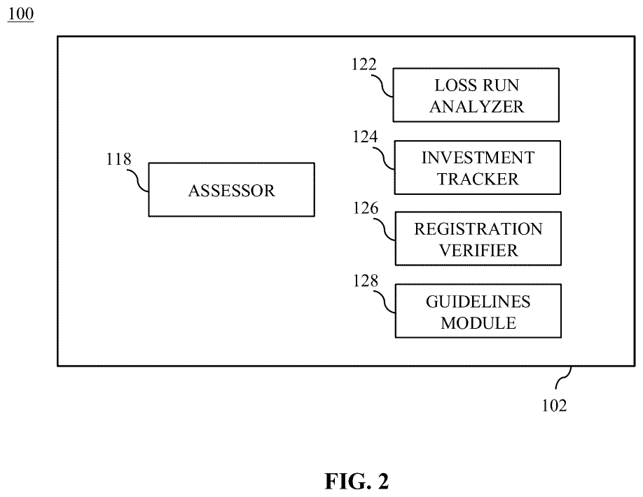

With reference to FIG. 2, underwriting server 102 is communicatively coupled to client devices 106-108 over network 104. Underwriting server 102 is configured to receive electronically transmitted information representing an application for a surety bond from principal device 106. The electronically transmitted information may include at least the name of the principal, the name of the obligee, and the penal sum. Underwriting server 102 comprises multiple communicatively coupled computer system components configured to aggregate electronic content that shows whether one or more guidelines for the surety bond are met including loss run analyzer 122, investment tracker 124, registration verifier 126, and guidelines module 128.

Loss run analyzer 122 is configured to retrieve a loss run report from principal device 106 and analyze the principal's loss history with obligee device 107. Investment tracker 124 is configured to retrieve a portfolio of the principal's investments comprising stocks, bonds, cash, and real estate from principal device 106. Registration verifier 126 is configured to interface with state insurance department server 116 to retrieve registration information about the principal and obligee and verify their registration status. Registration verifier 126 checks for approval from the state insurance department for the state in which the obligee is domiciled.

Guidelines module 128 stores electronic content comprising additional underwriting guidelines utilized by underwriting server 102. The electronic content stored in guidelines module 128 include investment guidelines, contractual data retrieved by contractual data aggregator 112 from database 110, the entity structure or an organization chart of the principal, an introductory presentation of the organization, certified financial statements for the Managing General Underwriter, Managing General Agent, reinsurance companies (with common ownership to the Managing General Underwriter), and holding companies, and policy counts by line of business (e.g., policy effective date and expiration date, policy count, earned premium, total premium, and unearned premium).

Underwriting server 102 further comprises an assessor 118. Assessor 118 is configured to analyze the aggregated electronic content from computer system components 122-128 to verify whether the guidelines for the surety bond are met. Assessor 118 is further configured to perform underwriting for the surety bond in the application from principal device 106 based on the verification, store underwriting data in a cache or another memory location associated with client devices 106-108, and generate a surety bond based on the underwriting. In some embodiments, assessor 118 is configured to generate the surety bond in response to a change in the stored underwriting data or elapsing of a predetermined amount of time.

In an embodiment, generation of the surety bond by assessor 118 is configurable to be automatically triggered based on information contained in the underwriting data. The information in the cache or other memory may be periodically updated by underwriting server 102. The trigger can be set to activate a message or a flag to generate a message based on an elapsed predetermined amount of time or a change to the information in the cache or memory. As such, an up-to-date surety bond may be presented to the client devices 106-108.

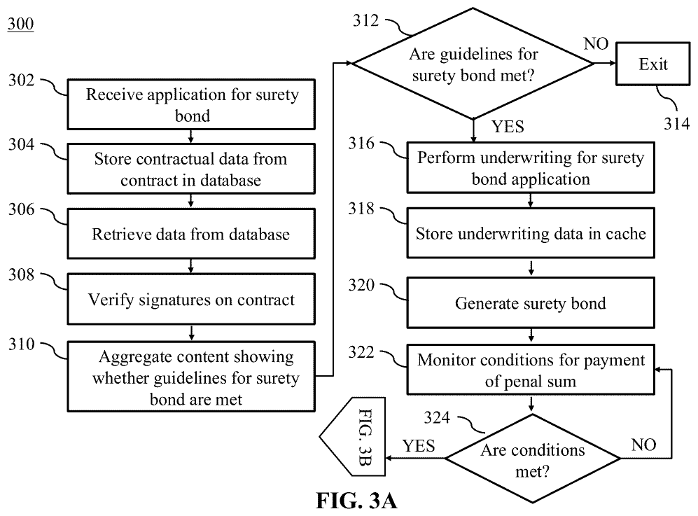

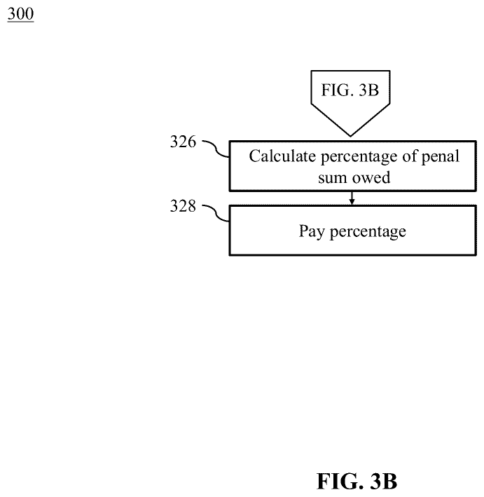

With reference to FIGS. 3A and 3B, a process 300 of using system 100 to obtain a surety bond in accordance with some embodiments will now be described. The process of FIGS. 3A and 3B comprises steps 302 through 328 and is suitable for use in system 100 but is more generally applicable to other types of systems for obtaining a surety bond.

At step 302, underwriting server 102 receives electronically transmitted information representing an application for a surety bond from principal device 106. The electronically transmitted information may include at least the name of the principal, the name of the obligee, and the penal sum. In an embodiment, an applicant may electronically submit information associated with an application or questionnaire for a surety bond to underwriting server 102 from principal device 106 or a computing device using an electronic user and/or web interface. Alternatively, the information may be electronically transmitted to underwriting server 102 by an agent, salesperson, or an employee of an insurer from a client interface of a computing device.

At step 304, database 110 electronically stores contractual data from a contract executed between principal device 106 and obligee device 107. In an embodiment, the contract comprises an interest and liabilities contract (see Appendix B). At step 306, contractual data aggregator 112 retrieves the contractual data from database 110 and at step 308, verifies signatures from principal device 106 and obligee device 107 on the contract. In some embodiments, signatures on the contract are executed using electronic or digital methods including DocuSign™, Adobe™ Sign, HelloSign™, and other electronic signature services.

At step 310, the communicatively coupled computer system components of underwriting server 102 aggregate electronic content that shows whether one or more guidelines for the surety bond are met. As discussed with reference to FIG. 2 above, the computer system components of underwriting server 102 include loss run analyzer 122, investment tracker 124, registration verifier 126, and guidelines module 128.

At step 312, assessor 118 analyzes the aggregated electronic content from computer system components 122-128 to verify whether one or more of the guidelines for the surety bond are met. Analyzing the electronic content may include assessor 118 parsing data fields from the electronic content and verifying information (matching the data fields) such as loss run reports, investment portfolios, and registration status. Verifying the information may include activities performed by assessor 118 such as searching, retrieving, or querying public and private electronic databases containing data records that confirm the electronic content received by underwriting server 102.

If assessor 118 determines that the guidelines for the surety bond are not met, system 100 exits process 300 at step 314. The surety bond application may be rejected if, for example, the risk presented by the application exceeds a given underwriting threshold. A rejection message, signal or flag may be configured to notify client devices 106-108 that the application has been rejected.

If assessor 118 verifies that one or more guidelines for the surety bond are met, at step 316, assessor 118 performs underwriting for the surety bond in the application from principal device 106 based on the verification. At step 318, assessor 118 stores underwriting data in a cache or another memory location associated with client devices 106-108. At step 320, assessor 318 generates and presents to client devices 106-108 a surety bond based on the underwriting (see Appendix A).

Assessor 118 utilizes a stored template to generate and present the surety bond. The stored template comprises blank placeholders for data such as the names of the principal, obligee, and surety, the penal sum, the bond number, the bond term, date of execution, etc. Assessor 118 automatically fills in the data to complete the surety bond before presenting it to client devices 106-108.

The surety bond may be transmitted from underwriting server 102 to client devices 106-108 or to a client device of an insurance agent or other salespersons by electronic means such as email, text message, chat message, social media, or provided as an electronic file on a user interface. Providing the surety bond may include asking client devices 106-108 to submit additional information and to agree to certain terms to complete the surety bond application.

In some embodiments, assessor 118 is configured to generate the surety bond in response to a change in the stored underwriting data or elapsing of a predetermined amount of time. The information in the cache or other memory may be periodically updated by underwriting server 102. The trigger can be set to activate a message or a flag to generate a message based on an elapsed predetermined amount of time or a change to the information in the cache or memory. As such, an up-to-date surety bond may be presented to the client devices 106-108.

If any one or all of client devices 106-108 declines to purchase the surety bond or does not accept the surety bond within a predetermined amount of time, the surety bond may either be saved in a database for future reference or discarded, and one or more of the steps described above can be repeated for the next surety bond application.

Steps required to issue a surety bond may vary. For example, where the principal device 106 or a party authorized to act on behalf of the principal transmits information and acceptance of the surety bond to underwriting server 102, the surety bond may issue automatically or at some predetermined time thereafter, e.g., 30 days, etc. If, however, the transmission of information and acceptance of the surety bond is from an insurance agent with limited authority to bind the principal, the surety bond may issue only after first being reviewed and accepted by the principal. In any event, if the surety bond issues, the information received and any other relevant information are stored in an appropriate database.

At step 322, monitoring module 114 monitors one or more conditions for payment of the penal sum. For example, conditions for payment of the penal sum may comprise a failure by principal device 106 to pay an amount owed under the contract, a court order or settlement agreement requiring obligee device 107 to make a payment demand upon surety device 108, or an amendment, modification, cancellation, termination, or non-renewal of the surety bond.

At step 324, monitoring module 114 determines whether the one or more conditions for payment of the penal sum are met. If one or more of the conditions are not met, process 300 proceeds to step 322 and continues to monitor the conditions.

If monitoring module 114 determines that one or more conditions for payment of the penal sum are met, at step 326, payment module 120 calculates a percentage of the penal sum owed to obligee device 107. In an embodiment, the calculated percentage may be some or all of the penal sum. At step 328, payment module 120 pays the calculated percentage to obligee device 107.

The particular processing operations and other system functionality described in conjunction with the flow diagram of FIGS. 3A and 3B are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the process of FIGS. 3A and 3B may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

FIGS. 1 through 3B are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. An automated computerized system for providing a surety bond, the system comprising a plurality of computing devices communicatively coupled to one another over a network, the system comprising:
an underwriting server communicatively coupled to a client device over the network to receive from the client device first electronically transmitted information representing an application for a surety bond, the first electronically transmitted information including at least a name of a principal, a name of an obligee, and a penal sum;
a database electronically storing contractual data from a contract between the principal and obligee;
a contractual data aggregator configured to retrieve data from the database and to verify signatures on the contract;
a monitoring module configured to monitor whether one or more conditions for payment of the penal sum are met; and
the underwriting server comprising:
a plurality of communicatively coupled computer system components configured to aggregate electronic content that shows whether one or more guidelines for the surety bond are met; and
an assessor configured to analyze the aggregated electronic content to verify whether the one or more guidelines for the surety bond are met, perform underwriting for the surety bond in the application based on the verification, store underwriting data in a cache associated with the client device, and generate a surety bond based on the underwriting.

2. The system of claim 1, wherein the surety bond guarantees unearned premium for an unauthorized reinsurance company.

3. The system of claim 1, wherein the assessor is configured to generate the surety bond in response to a change in the stored underwriting data or elapsing of a predetermined amount of time.

4. The system of claim 1, wherein the contract between the principal and obligee is an interest and liabilities contract.

5. The system of claim 1, wherein the one or more conditions for payment of the penal sum comprise a failure by the principal to pay an amount owed under the contract, a court order or settlement agreement requiring the obligee to make a payment demand upon the surety, and an amendment, modification, cancellation, termination, or non-renewal of the surety bond.

6. The system of claim 1, the system further comprising a payment module which, based on a determination by the monitoring module that one or more conditions for payment of the penal sum are met, is configured to:
calculate a percentage of the penal sum owed, wherein the percentage may be some or all of the penal sum; and
pay the percentage.

7. The system of claim 1, wherein the plurality of computer system components comprises at least a loss run analyzer configured to retrieve a loss run report from the principal and analyze the principal's loss history with the obligee.

8. The system of claim 1, wherein the plurality of computer system components comprises at least an investment tracker configured to retrieve a portfolio of the principal's investments comprising stocks, bonds, cash, and real estate.

9. The system of claim 1, wherein the plurality of computer system components comprises at least a registration verifier configured to interface with a state insurance department server to retrieve registration information about the principal and obligee and verify their registration status.

10. An automated computerized method for providing a surety bond, the method being performed by a plurality of computing devices communicatively coupled to one another over a network, the method comprising:
receiving, by an underwriting server communicatively coupled to a client device over the network, first electronically transmitted information representing an application for a surety bond from the client device, the first electronically transmitted information including at least a name of a principal, a name of an obligee, and a penal sum;
storing, by an electronic database, contractual data from a contract between the principal and obligee;
retrieving, by a contractual data aggregator, data from the electronic database;
verifying, by the contractual data aggregator, signatures on the contract;
monitoring, by a monitoring module, whether one or more conditions for payment of the penal sum are met;
aggregating, by a plurality of communicatively coupled computer system components on the underwriting server, electronic content that shows whether one or more guidelines for the surety bond are met;
analyzing, by an assessor on the underwriting server, the aggregated electronic content to verify whether the one or more guidelines for the surety bond are met;
performing, by the assessor, underwriting for the surety bond in the application based on the verification;
storing, by the assessor, underwriting data in a cache associated with the client device; and
generating, by the assessor, a surety bond based on the underwriting.

11. The method of claim 10, wherein generating the surety bond comprises generating a surety bond guaranteeing unearned premium for an unauthorized reinsurance company.

12. The method of claim 10, wherein generating the surety bond comprises generating, by the assessor, the surety bond in response to a change in the stored underwriting data or elapsing of a predetermined amount of time.

13. The method of claim 10, wherein storing contractual data from the contract between the principal and obligee comprises storing contractual data from an interest and liabilities contract between the principal and obligee.

14. The method of claim 10, wherein monitoring whether one or more conditions for payment of the penal sum are met comprises monitoring for a failure by the principal to pay an amount owed under the contract, a court order or settlement agreement requiring the obligee to make a payment demand upon the surety, and an amendment, modification, cancellation, termination, or non-renewal of the surety bond.

15. The method of claim 10, the method further comprising, based on a determination by the monitoring module that one or more conditions for payment of the penal sum are met:
calculating, by a payment module, a percentage of the penal sum owed, wherein the percentage may be some or all of the penal sum; and
paying, by the payment module, the percentage.

16. The method of claim 10, wherein the method further comprises:
retrieving, by a loss run analyzer, a loss run report from the principal; and
analyzing, by the loss run analyzer, the principal's loss history with the obligee.

17. The method of claim 10, wherein the method further comprises retrieving, by an investment tracker on the underwriting server, a portfolio of the principal's investments comprising stocks, bonds, cash, and real estate.

18. The method of claim 10, wherein the method further comprises:
interfacing, by a registration verifier, with a state insurance department server to retrieve registration information about the principal and obligee; and
verifying, by the registration verifier, the registration status of the principal and obligee.

19. Non-transitory computer-readable media comprising program code that when executed by a programmable processor in an underwriting server causes execution of an automated computerized method for providing a surety bond, the method being performed by a plurality of computing devices communicatively coupled to one another over a network, the program code comprising:
computer program code for receiving, by an underwriting server communicatively coupled to a client device over the network, first electronically transmitted information representing an application for a surety bond from the client device, the first electronically transmitted information including at least a name of a principal, a name of an obligee, and a penal sum;
computer program code for storing, by an electronic database, contractual data from a contract between the principal and obligee;
computer program code for retrieving, by a contractual data aggregator, data from the electronic database;
computer program code for verifying, by the contractual data aggregator, signatures on the contract;
computer program code for monitoring, by a monitoring module, whether one or more conditions for payment of the penal sum are met;
computer program code for aggregating, by a plurality of communicatively coupled computer system components on the underwriting server, electronic content that shows whether one or more guidelines for the surety bond are met;
computer program code for analyzing, by an assessor on the underwriting server, the aggregated electronic content to verify whether the one or more guidelines for the surety bond are met;
computer program code for performing, by the assessor, underwriting for the surety bond in the application based on the verification;
computer program code for storing, by the assessor, underwriting data in a cache associated with the client device; and
computer program code for generating, by the assessor, a surety bond based on the underwriting.

20. The non-transitory computer-readable media of claim 19, wherein generating the surety bond comprises generating a surety bond guaranteeing unearned premium for an unauthorized reinsurance company.
